(19) United States
(12) Patent Application Publication
(10) Pub. No.: US 2010/0247836 A1
(43) Pub. Date: Sep. 30, 2010

(54) METHOD FOR THE LASER ABLATION OF BRITTLE COMPONENTS

(76) Inventors: Claus Peter Kluge, Roslau (DE); Michael Hemerle, Marktredwitz (DE)

Correspondence Address: FULBRIGHT & JAWORSKI, LLP, 666 FIFTH AVE, NEW YORK, NY, 10103-3198, US

(21) Appl. No.: 12/741,429

(22) PCT Filed: Nov. 7, 2008
(86) PCT No.: PCT/EP08/65096

§ 371 Date: May 5, 2010

(30) Foreign Application Priority Data
Nov. 7, 2007 (DE) 10 2007 000 647.2

(51) Int. Cl. B32B 3/30; B29C 35/08

(52) U.S. Cl. 428/43; 264/400

(57) ABSTRACT

Method for the laser ablation of brittle components in preparation for the subsequent separation of the same, by the introduction of sack-like indentations by a laser beam, wherein the indentations are arranged in a line one after the other, and form a laser ablation line which serves as the fracture initiation line, wherein the term laser ablation line means a line formed by connecting the middle points of all the indentations. At least two laser ablation lines are introduced onto the component surface and cross each other at a cross point. In order to ensure that the fracture always runs along the laser ablation line during the separation process, that fractures deviating from the laser ablation line are avoided, and that the corners of the separated pieces following fracturing are evenly shaped, it is suggested according to the invention that at least one cross point indentation is introduced at the cross point in a targeted, controlled, and intentional manner, which specifically weakens the component at the cross point.

The invention relates to a method for laser scribing of brittle components in preparation for the subsequent singulation of the same, according to the preamble of Claim 1, and to a component that has been machined by this method.

Such a method is used to replace mechanical cutting methods, and has also become established, as laser drilling, in scribing technology. In this case, blind holes are arranged in a line one after the other, and serve as predetermined breaking edges in the case of brittle materials such as cast metal or ceramics. This method is also used for singulating ceramic plates.

In laser scribing, it is standard practice for indentations to be made at defined intervals in the material. In this case, random overlaps of the indentations occur at the points of intersection of the x and y lines. The part can subsequently be broken along the resultant scribe lines. Owing to the points of intersection being undefined, the break at the intersections can undergo alteration in any random direction, resulting in the parts being defective.

In the following, a laser scribe line or laser track is understood to be a notional line that passes through the mid-point of all indentations.

The invention is based on the object of specifying a method for laser scribing by which it is ensured that, in the singulation process, the break always runs along the laser scribe line, breaks deviating from the laser scribe line are prevented, and the corners of the singulated parts following breaking are evenly shaped.

This object is achieved, according to the invention, in that there is applied at the intersection point at least one selectively controlled, non-randomly produced intersection-point indentation, which selectively weakens the component at the intersection point. It is thereby ensured that the break always runs along the laser scribe line. Breaks deviating from the laser scribe line are prevented, and the corners of the singulated parts following breaking are evenly shaped.

In a preferred embodiment, indentation is effected in a selectively controlled manner at the intersection point at least one further time. This selectively weakens the intersection point.

In a development of the invention, the intersection-point indentation or indentations made in the intersection point are controlled in such a way that their depth is equal to or greater than the depth of the indentations, on the laser scribe lines, that surround the intersection point. A greater depth means a greater weakening of the component at the intersection point.

A laser scribe line can also terminate in the intersection point. In this case, the laser scribe lines in the region of the intersection point form a T shape, rather than an x shape. This, however, is also understood to be an intersection point.

In a development of the invention, laser scribe lines are applied to two opposing surfaces of the component, in such a way that they are located on two intersecting planes and the intersection-point indentations are located on the intersection line of the planes. This greatly facilitates breaking along the laser scribe lines.

Preferably, at least one further selectively controlled, non-randomly produced indentation is also applied to indentations that are not located on an intersection point. The entire laser scribe line is thereby weakened.

The indentations, and consequently the laser scribe lines, are preferably applied in such a way that at least three singulated parts are produced after the laser-scribed component has been broken along the laser scribe lines. The laser scribe lines need not run rectilinearly, but can also run in curved lines.

In a development of the invention, all intersection points are weakened by at least two selectively controlled intersection-point indentations. It is thereby ensured that effectively all intersection points are also weakened.

A component produced by the method just described is preferably composed of ceramics, such as aluminium oxide, zirconium oxide, aluminium nitride, silicon nitride, or of glass. Combinations of these materials may also be used.

In one embodiment, bores or notches are made in the component. The laser scribing can be effected simultaneously with the application of these bores or notches.

In a preferred embodiment, the components are realized in the form of a plate, and are composed of a ceramic having a thickness of less than or equal to 1.7 mm. This thickness is especially suitable for the described method according to the invention.

Preferably, the components have at least two plane-parallel surfaces. This simplifies production. However, the components can also be three-dimensional.

In a preferred development of the invention, intersecting laser scribe lines are arranged at an angle of 90°±1′, i.e. at right angles, in relation to one another. Rectangular components are thereby produced following breaking.

Preferably, the components are ceramic plates that are used as a substrate for electronic or electrical components.

The invention is explained more fully in the following with reference to figures.

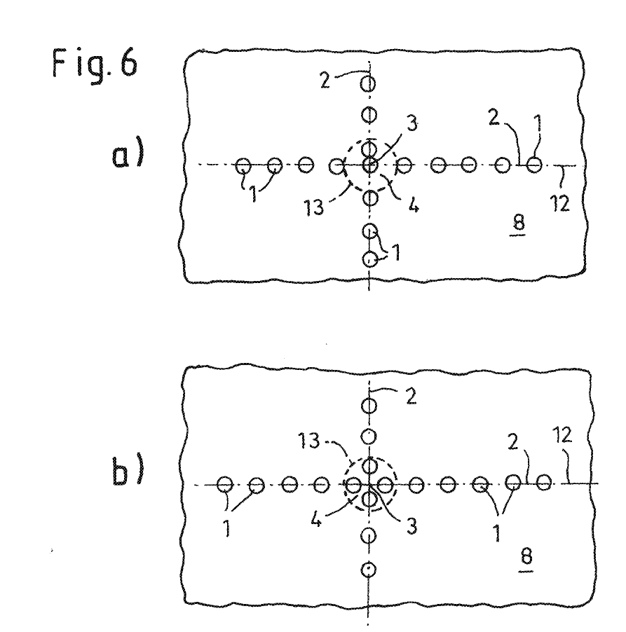

Laser scribing according to the prior art is shown by FIG. 6, with reference to three embodiments. Blind indentations 1 of a laser beam are applied to a component 8 in preparation for its subsequent singulation. These indentations 1 are arranged in a line one after the other and constitute a laser scribe line 2, which serves as a break initiation line in the subsequent breaking of the component into individual, smaller components. Here, and in the entire description relating to this invention, a laser scribe line 2 is understood to be a notional line that passes through the mid-point of all indentations 1. At least two laser scribe lines 2, which intersect one another at an intersection point 3, are applied to the component 8. The indentations 1 in the region 13 of the intersection points 3 have a random arrangement. In the region 13, they may be arranged next to one another (FIG. 6b), or so as to overlap one another (FIG. 6a), or so as to contact one another (FIG. 6c). The break initiation line is not sharply defined at the intersection point. Consequently, the break at the intersection points can undergo alteration to any random direction, resulting in the parts being defective.

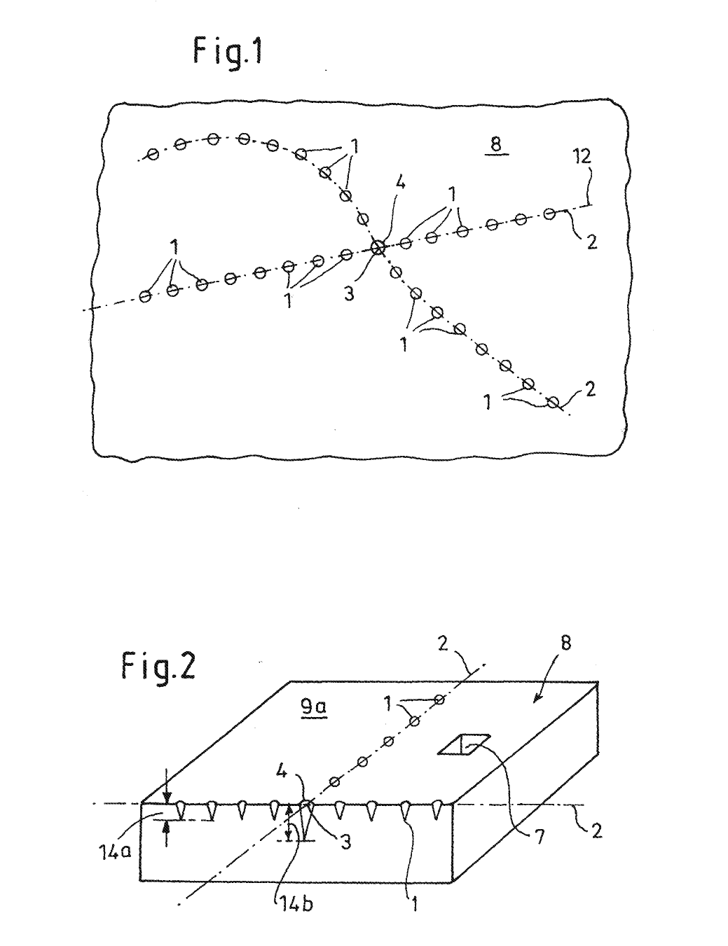

The invention is shown schematically in FIG. 1, with reference to two laser scribe lines 2 on a component 8 that pass through the mid-point of all indentations 1. Applied to the intersection point 3 of the two laser scribe lines 2 is a selectively controlled, non-randomly produced intersection-point indentation 4, which selectively weakens the component 8 at the intersection point 3. Even if one or more indentations have been applied by chance to the region 13 (see FIG. 6) around the intersection point, at least one selectively controlled, non-randomly produced intersection-point indentation 4 is thus always applied. An intersection-point indentation 4 is understood to be an indentation made in the intersection point 3 of the laser scribe lines 2.

FIG. 2 shows a component 8 having a surface 9a, to which indentations 1, constituting two laser scribe lines 2, have been applied by means of a laser beam. An intersection-point indentation 4 has been applied to the intersection point 3 of these laser scribe lines 2. The depth of the indentations is denoted by the reference 14a, and the depth of the intersection-point indentation 4 is denoted by the reference 14b. As shown by FIG. 2, the depth 14h of the intersection-point indentation 4 is greater than the depth 14a of the indentations 1. The intersection point 3 is thereby selectively weakened to a greater extent than the surrounding indentations 1. FIG. 2 also shows a cornered bore 7 in the component 8, i.e. the component 8 can be realized in any manner, depending on the application.

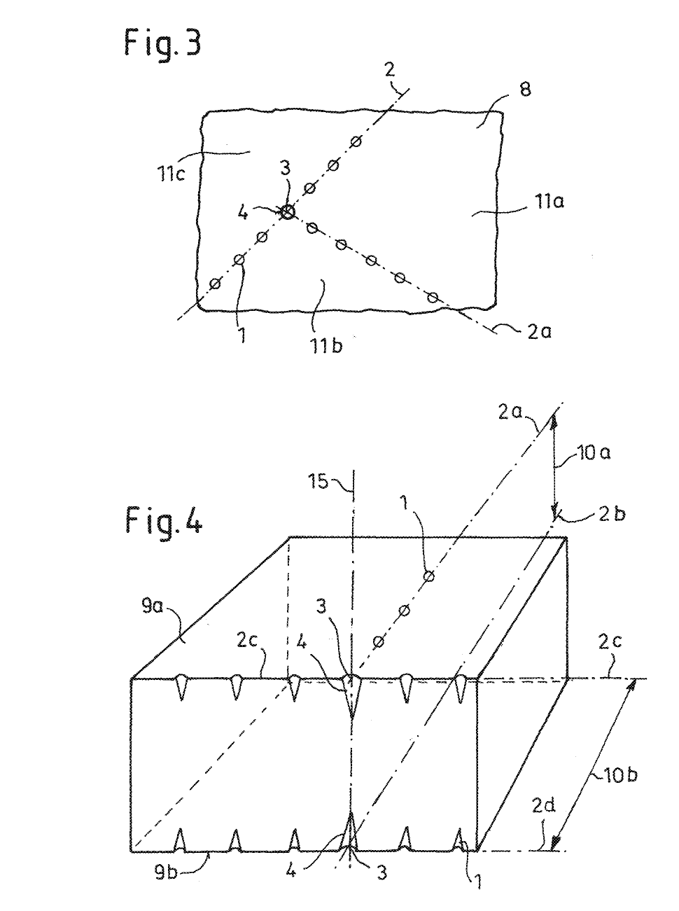

FIG. 3 shows a component 8 having two laser scribe lines 2, of which one terminates in the intersection point 3 of the other laser scribe line. This intersection point 3, likewise, is weakened by an intersection-point indentation 4. In this case, the laser scribe lines 2 in the region of the intersection point 3 form a T shape, rather than an x shape. This, however, is also understood to be an intersection point. In this case, three components, denoted by 11a, 11b, 11c, are produced after the component 8 has been broken along the laser scribe lines 2.

FIG. 4 shows a component 8 having two surfaces 9a, 9b, on which indentations 1 constitute intersecting laser scribe lines 2. In this case, the laser scribe lines 2 are arranged in such a way that they are located on two intersecting planes 10a, 1b, a first plane 10a being constituted by the laser scribe lines 2a, 2b and the second plane 10b being constituted by the laser scribe lines 2c, 2d. In this case, the laser scribe lines 2a, 2c are located on the surface 9a, and the laser scribe lines 2b, 2d are located on the surface 9b. The intersection-point indentations 4 of both surfaces 9a, 9b are located on the intersection line 15 of the two planes 10a, 10b. The component is thereby weakened from “above” and from “below” at the intersection points 3 by two intersection-point indentations 4.

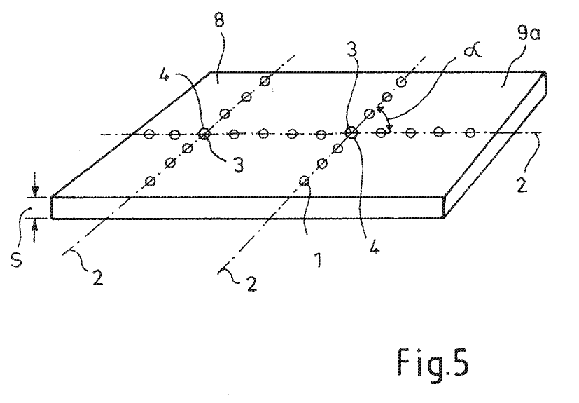

FIG. 5 shows a component 8 in the form of a plate, having a thickness S of 1.7 mm and having a surface 9a, to which laser scribe lines 2 are applied. Each two intersecting laser scribe lines 2 together form an angle α of 93°+−1°. Here, likewise, there is applied to the intersection points 3 at least one selectively controlled, non-randomly produced intersection-point indentation 4, which selectively weakens the component 8 at the intersection point 3. Such plate-type components 8 are ceramic plates that are used as a substrate for electronic or electrical components. Their thickness S is preferably less than or equal to 1.7 mm.

The positional tolerance of the double indentations is maximally ±30 μm. It is thereby ensured that the break always runs along the laser scribe line. Breaks deviating from the laser scribe line are prevented. The corners of the singulated parts following breaking are evenly shaped.

The object of this invention was to indent a component in a selectively controlled manner by laser scribing. Following laser scribing, the component is preserved as a piece, and can be broken at a subsequent point in time by the application of an external force along the laser scribe lines.

In the case of this method, the laser appliance is controlled is such a way that at least one indentation, applied in a selectively controlled (non-randomly produced) manner, is produced on a surface of the part, at least one intersection point of at least two laser lines having any angle of the intersection lines. At the intersection point of two laser scribe lines, indentation is effected in a selectively controlled manner at least one second time into the same indentation that defines the intersection point.

1-14. (canceled)

15. A method for laser scribing of brittle components, in preparation for the subsequent singulation of the same, through application of blind indentations of a laser beam, the indentations being arranged in a line one after the other and constituting a laser scribe line, which serves as a break initiation line, a laser scribe line being understood to be a notional line that passes through the mid-point of all indentations, and at least two laser scribe lines, which intersect one another at an intersection point, being applied to the component, wherein there is applied at the intersection point at least one selectively controlled, non-randomly produced intersection-point indentation, which selectively weakens the component at the intersection point.

16. A method according to claim 15, wherein indentation is effected in a selectively controlled manner at the intersection point at least one further time.

17. A method according to claim 15, wherein the intersection-point indentation or indentations are controlled in such a way that their depth is equal to or greater than the depth of the indentations, on the laser scribe lines, that surround the intersection point.

18. A method according to claim 15, wherein one laser scribe line terminates in the intersection point.

19. A method according to claim 15, wherein laser scribe lines are applied to two opposing surfaces of the component, in such a way that they are located on two intersecting planes and the intersection-point indentations are located on the intersection line of the planes.

20. A method according to claim 15, wherein at least one further selectively controlled, non-randomly produced indentation is also applied to indentations that are not located on an intersection point.

21. A method according to claim 15, wherein the indentations, and consequently the laser scribe lines, are applied in such a way that at least three singulated parts are produced after the laser-scribed component has been broken along the laser scribe lines.

22. A method according to claim 15, wherein all intersection points are weakened by at least two selectively controlled intersection-point indentations.

23. A component produced by the method according to claim 15, wherein that the component is composed of ceramics, such as aluminium oxide, zirconium oxide, aluminium nitride, silicon nitride, or of glass.

24. A component according to claim 23, wherein bores or notches are also made in the component.

25. A component according to claim 23, wherein that the components are realized in the form of a plate, and are composed of a ceramic having a thickness of less than or equal to 1.7 mm.

26. A component according to claim 23, wherein that the components have at least two plane-parallel surfaces.

27. A component according to claim 23, wherein that intersecting, rectilinear laser scribe lines are arranged at an angle of 90°±1°, i.e. at right angles, in relation to one another.

28. A component according to claim 23, wherein that the components are ceramic plates that are used as substrates for electronic or electrical components.

29. A component according to claim 24, wherein bores or notches are also made in the component.

30. A component according to claim 24, wherein that the components are realized in the form of a plate, and are composed of a ceramic having a thickness of less than or equal to 1.7 mm.

31. A component according to claim 24, wherein that the components have at least two plane-parallel surfaces.

32. A component according to claim 24, wherein that intersecting, rectilinear laser scribe lines are arranged at an angle of 90°±1°, i.e. at right angles, in relation to one another.

33. A component according to claim 24, wherein that the components are ceramic plates that are used as substrates for electronic or electrical components.

34. A component according to claim 25, wherein that intersecting, rectilinear laser scribe lines are arranged at an angle of 90°±1°, i.e. at right angles, in relation to one another.
